(19) United States
(12) Patent Application Publication
(10) Pub. No.: US 2023/0327573 A1
(43) Pub. Date: Oct. 12, 2023

(54) CONVERTER HAVING WIRING STATE DETECTION UNIT AND MOTOR DRIVE DEVICE

(71) Applicant: FANUC CORPORATION, Yamanashi (JP)

(72) Inventor: Takaaki TAGAWA, Yamanashi (JP)

(21) Appl. No.: 18/042,456

(22) PCT Filed: Oct. 19, 2021
(86) PCT No.: PCT/JP2021/038652

§ 371 Date: Feb. 22, 2023

(30) Foreign Application Priority Data
Oct. 26, 2020 (JP) 2020-178705

(51) Int. Cl. H02M 5/458; H02M 1/00; H02M 7/217; H02M 1/32

(52) U.S. Cl. CPC H02M 5/4585; H02M 1/0009; H02M 7/217; H02M 1/32

(57) ABSTRACT

A converter includes: a power converter for selectively executing a rectification operation for converting alternating-current (AC) power on a three-phase alternating-current power supply side into direct-current (DC) power output on a DC side, and a regenerative operation for converting DC power on the DC side into AC power output on the AC side; a voltage detector for detecting a voltage value regarding each of phase voltages input from the AC side; a controller for controlling the rectification operation and regenerative operation based on arithmetic operation processing using the voltage value; a current detector for detecting a regenerative current value from the power converter to the AC side in the regenerative operation; and a wiring state detector for detecting a wiring state between the voltage detector and the AC power supply based on a comparison between the regenerative current value and a predetermined threshold value.

### TECHNICAL FIELD

The present invention relates to a converter including a wiring state detection unit, and a motor driving apparatus.

### BACKGROUND ART

In a motor driving apparatus that controls the driving of a motor in a machine tool, a forging machine, an injection molding machine, an industrial machine, or a robot of any kind, AC power supplied from a three-phase AC power supply is converted to DC power by a converter (rectifier) and the DC power is output to a DC link, and the DC power in the DC link is further converted to AC power by an inverter and the AC power is supplied to the motor as motor driving power.

As the converter in the motor driving apparatus, a converter is widely used which includes a power supply regeneration function that returns regenerative power occurring at a time of deceleration of the motor to the three-phase AC power supply side. The converter with the power supply regeneration function includes a power conversion unit including a bridge circuit of a power element composed of a diode and a switching element connected to the diode in an inverse parallel manner. Control methods of the converter with the power supply regeneration function include a PWM control method and a 120-degree power conduction method.

The converter is provided with an input voltage detection unit for detecting voltage detection values of individual phases of the three-phase AC power supply. The voltage detection values detected by the input voltage detection unit are used for each of processes in the converter, such as a power conversion process of the power conversion unit or a power failure detection process of the three-phase AC power supply. For example, the regeneration operation of the converter is implemented by detecting voltage detection values of the individual phases of the three-phase AC power supply by the input voltage detection unit, and controlling the power conversion unit such that a switching element provided in an upper arm of the phase in which the voltage detection value becomes maximum is turned on and a switching element of a lower arm provided in the phase in which the voltage of the three-phase AC power supply becomes minimum is turned on. A connection unit of the input voltage detection unit is provided with input terminals corresponding to the respective phases of the three-phase AC power supply. In order to correctly execute the processes in the converter, it is important to perform correct wiring between the respective phases of the three-phase AC power supply and the input terminals of the corresponding phases in the input voltage detection unit.

For example, there is known a protection method of an inverter, wherein in an inverter apparatus including a converter unit that converts AC voltage to DC voltage; a converter current detection circuit that detects current flowing in the converter unit; an inverter unit that converts the DC voltage to three-phase AC voltage; a regenerative power discharge circuit composed of a resistor and a switching element connected to an output of the converter unit; a regenerative discharge driving circuit that drives the regenerative power discharge circuit; and a CPU that executes control of the inverter unit, when power supply to the inverter is turned on, the regenerative discharge driving circuit is operated to cause current to flow through the regenerative power discharge circuit, the CPU determines whether the current is detected by the converter current detection circuit, and, when the current does not flow, the driving operation of the inverter is prohibited (see, for example, PTL 1).

For example, there is known a power conversion apparatus including a rectification circuit that includes an input terminal for connection to an AC power supply and converts an AC output supplied from the input terminal to a DC output; an inverter circuit that constitutes a bridge circuit in which a plurality of series-connected circuit units are connected in parallel, each of the series-connected circuit units being configured such that a shunt resistor is connected to a pair of switch units in which circuit units each including a switching element and a rectification element, which are connected in an inverse parallel manner, are connected in series, both ends of the bridge circuit being connected between both ends of a capacitor that accumulates the DC output from the rectification circuit, and the inverter circuit supplying AC power to a predetermined load apparatus via a load connection terminal that is led out from a connection portion of the pair of switch units; and a control unit that outputs to the inverter circuit a switching element control signal for controlling conduction of the switching element of the circuit unit, and detects current flowing in the shunt resistor, wherein the control unit generates such switching element control signals as to turn on all the switching elements of the circuit units connected to the shunt resistors of the pairs of switching units, and outputs the switching element control signals to the inverter circuit, and presence/absence of an erroneous connection of a power supply apparatus in the load connection terminal is determined according to whether current is zero or not, based on a current detection signal detected by an input of the switching element control signals (see, for example, PTL 2).

For example, there is known a power conversion apparatus including a state data detection unit that detects state data entering a regenerative converter from a three-phase power supply at a time of switching of a main circuit terminal; a comparison unit that compares the state data detected by the state data detection unit and a predetermined threshold; and a determination unit that determines a wiring state between the three-phase power supply entering a main circuit and the three-phase power supply entering a phase detection circuit, based on a comparison result by the comparison unit (see, for example, PTL 3).

For example, there is known an abnormality detection method of an AC-AC converter, wherein in the AC-AC converter that converts AC power supply voltage to AC voltage of a freely selected magnitude and frequency by ON/OFF of a semiconductor switching element, an inverse connection state, in which a proper output terminal of the converter is connected to an AC power supply side and a proper input terminal is connected to a load side, is detected by using AC voltage information applied to the proper input terminal of the converter and rectification voltage information of AC voltage applied to the proper output terminal of the converter (see, for example, PTL 4).

### CITATION LIST

### Patent Literature

[PTL 1] JP 2000-139082 A
[PTL 2] JP 2008-253008 A
[PTL 3] JP 2014-195375 A
[PTL 4] JP 2006-352960 A

### SUMMARY OF INVENTION

### Technical Problem

In many cases, an operator that utilizes a converter performs a wiring work between a three-phase AC power supply and an input voltage detection unit in the converter. For such reasons as the operator being not familiar with the wiring work, or the operator being inadvertent, there is a possibility that a power line of each phase of the three-phase AC power supply is erroneously wired to an input terminal of a phase different from the corresponding phase in an input voltage detection unit. If there is erroneous wiring between the three-phase AC power supply and the input voltage detection unit, the converter and a motor driving apparatus including the converter are not able to correctly operate, and a problem such as an alarm stop or a fault arises. If the alarm stop due to the erroneous wiring occurs, the motor driving apparatus cannot be operated unless the three-phase AC power supply and the input voltage detection unit are correctly rewired, and the efficiency in work is low. Thus, in a converter with a power supply regeneration function and a motor driving apparatus including the converter, there is a demand for a technology for preventing an alarm stop or a fault due to erroneous wiring between a three-phase AC power supply and an input voltage detection unit in the converter.

### Solution to Problem

According to one mode of the present disclosure, a converter with a power supply regeneration function includes a power conversion unit configured to selectively execute a rectification operation of converting AC power, which is input from a three-phase AC power supply side, to DC power and outputting the DC power to a DC side, and a regeneration operation of converting DC power on the DC side to AC power and outputting the AC power to the three-phase AC power supply side; an input voltage detection unit configured to detect voltage detection values in regard to individual phase voltages that are input from the three-phase AC power supply side to the power conversion unit; a control unit configured to control the rectification operation and the regeneration operation of the power conversion unit, based on an arithmetic process using the voltage detection values; a regenerative current detection unit configured to detect a value of regenerative current flowing from the power conversion unit to the three-phase AC power supply side at a time of the regeneration operation of the power conversion unit; and a wiring state detection unit configured to detect a wiring state between the input voltage detection unit and the three-phase AC power supply, based on a comparison between a value of the regenerative current and a predetermined threshold.

In addition, according to one mode of the present disclosure, a converter with a power supply regeneration function includes a power conversion unit configured to selectively execute a rectification operation of converting AC power, which is input from a three-phase AC power supply side, to DC power and outputting the DC power to a DC side, and a regeneration operation of converting DC power on the DC side to AC power and outputting the AC power to the three-phase AC power supply side; an input voltage detection unit configured to detect voltage detection values in regard to individual phase voltages that are input from the three-phase AC power supply side to the power conversion unit; a control unit configured to control the rectification operation and the regeneration operation of the power conversion unit, based on an arithmetic process using the voltage detection values; a regenerative current detection unit configured to detect a value of regenerative current flowing from the power conversion unit to the three-phase AC power supply side at a time of the regeneration operation of the power conversion unit; an allocation unit configured to allocate tentative phase information to respective phases of the voltage detection values that are used in the arithmetic process by the control unit; and a phase information setting unit configured to set, when the control unit controls the regeneration operation of the power conversion unit by executing the arithmetic process by using the voltage detection values and the tentative phase information, the tentative phase information, which is allocated by the allocation unit when the regenerative current detection unit detects a minimum regenerative current, to be proper phase information used in the arithmetic process by the control unit.

Further, according to one mode of the present disclosure, a motor driving apparatus includes the above-described converter; and an inverter connected to the DC side of the converter and configured to convert DC power on the DC side to AC power for motor driving.

### Advantageous Effects of Invention

According to one mode of the present disclosure, in a converter with a power supply regeneration function and a motor driving apparatus including the converter, it is possible to prevent an alarm stop or a fault due to erroneous wiring between a three-phase AC power supply and an input voltage detection unit in the converter.

### BRIEF DESCRIPTION OF DRAWINGS

FIG. 1 is a diagram illustrating a converter and a motor driving apparatus according to a first embodiment of the present disclosure.

FIG. 2A is a diagram for describing a regeneration operation of a power conversion unit in the converter, and is a circuit diagram illustrating the power conversion unit composed of a three-phase bridge circuit.

FIG. 2B is a diagram for describing the regeneration operation of the power conversion unit in the converter, and is a diagram illustrating a relationship between a waveform of a three-phase AC power supply voltage at the time of power supply regeneration and a switching pattern of switching elements in power elements.

FIG. 3A is a circuit diagram for describing a relationship between a wiring state between a three-phase AC power supply and an input voltage detection unit, and regenerative current, and is a diagram illustrating a case where the respective phases of the three-phase AC power supply and input terminals of the input voltage detection unit are correctly wired.

FIG. 3B is a circuit diagram for describing the relationship between the wiring state between the three-phase AC power supply and the input voltage detection unit, and the regenerative current, and is a diagram illustrating a case where erroneous wiring is present between the respective phases of the three-phase AC power supply and the input terminals of the input voltage detection unit.

FIG. 4A is a waveform diagram illustrating a positive potential and a negative potential of a DC link voltage at the time of a regeneration operation of the converter, and voltage detection values detected by the input voltage detection unit, and illustrating a case where the respective phases of the three-phase AC power supply and the input terminals of the input voltage detection unit are correctly wired as illustrated in FIG. 3A.

FIG. 4B is a waveform diagram illustrating a positive potential and a negative potential of a DC link voltage at the time of a regeneration operation of the converter, and voltage detection values detected by the input voltage detection unit, and illustrating a case where erroneous wiring is present between the respective phases of the three-phase AC power supply and the input terminals of the input voltage detection unit, as illustrated in FIG. 3B.

FIG. 5 is a flowchart illustrating an operation flow of a wiring state detection process in the converter and the motor driving apparatus according to the first embodiment of the present disclosure.

FIG. 6 is a view exemplarily illustrating a relationship between phases of the three-phase AC power supply, and phases defined by tentative phase information.

FIG. 7 is a flowchart illustrating an operation flow of a phase information setting process in the converter and the motor driving apparatus according to the first embodiment of the present disclosure.

FIG. 8 is a diagram illustrating a converter and a motor driving apparatus according to a second embodiment of the present disclosure.

FIG. 9 is a flowchart illustrating an operation flow of a phase information setting process in the converter and the motor driving apparatus according to the second embodiment of the present disclosure.

### DESCRIPTION OF EMBODIMENTS

Hereinafter, a converter including a wiring state detection unit, and a motor driving apparatus are described with reference to the drawings. For the purpose of easier understanding, the scale in the drawings is changed as appropriate. A mode illustrated in each drawing is an example for implementation, and the mode is not limited to the illustrated one.

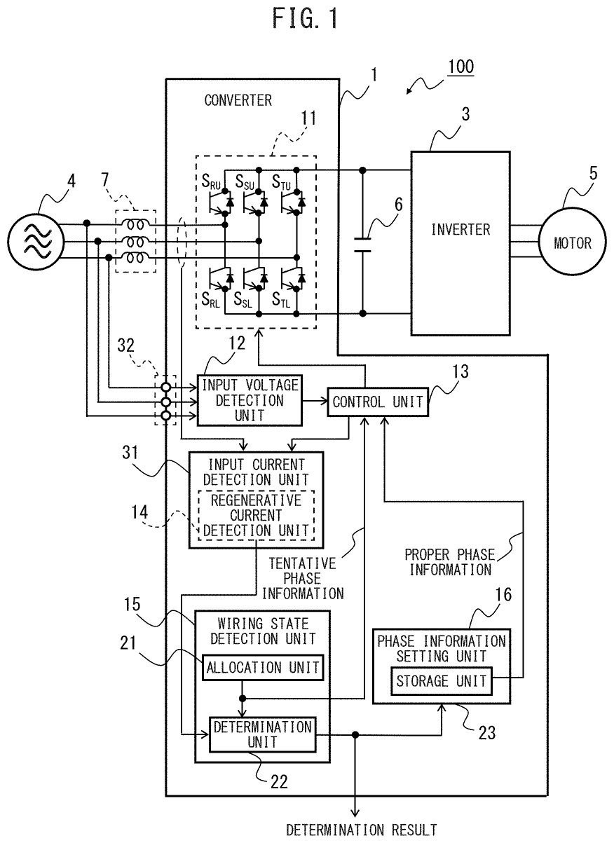

FIG. 1 is a diagram illustrating a converter and a motor driving apparatus according to a first embodiment of the present disclosure.

By way of example, a case is illustrated in which a motor 5 is controlled by a motor driving apparatus 100 that is connected to a three-phase AC power supply 4. Examples of the three-phase AC power supply 4 include a three-phase AC 400 V power supply, a three-phase AC 200 V power supply and a three-phase AC 600 V power supply. In the present embodiment, the kind of motor 5 is not particularly limited, and the motor 5 may be, for example, an induction motor or a synchronous motor. The number of phases of the motor 5 does not particularly limit the present embodiment, and may be, for example, three phases or a single phase. In the illustrated example, it is assumed that the motor 5 is a three-phase AC motor. Examples of a machine, in which the motor 5 is provided, include a machine tool, a robot, a forging machine, an injection molding machine, and an industrial machine.

As illustrated in FIG. 1, the motor driving apparatus 100 according to the first embodiment of the present disclosure includes a converter 1, an inverter 3, a DC link capacitor 6, and an AC reactor 7.

The converter 1 is configured as a rectifier capable of power supply regeneration, which can perform power conversion in both directions between AC power on the three-phase AC power supply 4 side and DC power of a DC link, by a rectification operation of a diode and an ON/OFF operation of a switching element.

The inverter 3 is connected to the DC output side of the converter 1. A circuit portion, which electrically connects the DC output side of the converter 1 and the DC input side of the inverter 3 is called “DC link”. Note that the DC link is also referred to as “DC link unit”, “direct-current link”, “direct-current link unit”, “DC bus”, or “DC intermediate circuit”.

The inverter 3 is composed of a full-bridge circuit of a switching element and a diode connected to the switching element in an inverse parallel manner. Examples of the switching element include an IGBT, an FET, a thyristor, a GTO (Gate Turn-OFF thyristor), and a transistor. In the example illustrated in FIG. 1, since the motor 5 is the three-phase AC motor, the inverter 3 is composed of a three-phase full-bridge circuit. When the motor 5 is a single-phase AC motor, the inverter 3 is composed of a single-phase bridge circuit.

By the ON/OFF operation of the switching element in the inside of the inverter 3 being PWM-controlled based on a command of an upper-level control apparatus (not illustrated), the inverter 3 converts DC power in the DC link to AC power and supplies the AC power to the motor 5 on the AC side, and converts AC power, which is regenerated by deceleration of the motor 5, to DC power and returns the DC power to the DC link. Based on the AC power supplied from the inverter 3, the speed, torque, or position of the rotor of the motor 5 is controlled. The upper-level control apparatus that controls the inverter 3 may be composed of a combination between an analog circuit and an arithmetic processing apparatus, or may be composed of only an arithmetic processing apparatus. The arithmetic processing apparatus, which can constitute the upper-level control apparatus that controls the inverter 3, may be, for example, an IC, LSI, CPU, MPU, or DSP.

The DC link capacitor 6 is provided in the DC link. The DC link capacitor 6 includes a function of accumulating DC power that is used for the inverter 3 to generate AC power, and a function of suppressing a pulsating component of the DC output of the converter 1. Examples of the DC link capacitor 6 include an electrolytic capacitor and a film capacitor.

The AC reactor 7 is provided between the AC input side of the converter 1 and the three-phase AC power supply 4.

Next, the converter 1 in the motor driving apparatus 100 according to the first embodiment of the present disclosure is described in greater detail.

According to the first embodiment of the present disclosure, the converter 1 includes a power conversion unit 11, an input voltage detection unit 12, a control unit 13, a regenerative current detection unit 14, a wiring state detection unit 15, and a phase information setting unit 16.

For example, at a time of installation or maintenance of the motor driving apparatus 100, an operator performs a wiring work between input terminals 32 of the input voltage detection unit 12 and power lines of individual phases of the three-phase AC power supply 4. The input voltage detection unit 12 detects voltage detection values in regard to the respective phase voltages that are input from the three-phase AC power supply 4 side to the power conversion unit 11 that is a main power conversion circuit of the converter 1. The voltage detection values in regard to the respective phase voltages, which are detected by the input voltage detection unit 12, are sent to the control unit 13 for controlling the power conversion unit 11. Note that, in some cases, the expression “wiring between input terminals 32 of the input voltage detection unit 12 and power lines of individual phases of the three-phase AC power supply 4” is described simply as “wiring between the input voltage detection unit 12 and the three-phase AC power supply 4” or a similar expression.

The control unit 13 controls the rectification operation and regeneration operation of the power conversion unit 11, based on an arithmetic process using the voltage detection values detected by the input voltage detection unit 12. At the time of the arithmetic process by the control unit 13, phase information is allocated to the voltage detection values for the three phases, which are detected by the input voltage detection unit 12. The phase information indicates which phase of an R phase, an S phase and a T phase each of the voltage detection values for the three phases corresponds to. The control unit 13 controls the power conversion operation of the power conversion unit 11 by executing an arithmetic process by using the voltage detection values of the respective phases, which are detected by the input voltage detection unit 12, and the phase information. Hereinafter, the phases defined by the phase information used in the arithmetic process of the control unit 13 are expressed as an R′ phase, an S′ phase and a T′ phase, and are thereby distinguished from the R phase, S phase and T phase that are actual phases of the three-phase AC power supply 4.

The power conversion unit 11 includes a three-phase bridge circuit in which a power element composed of a diode and a switching element connected to the diode in an inverse parallel manner is provided in each of an upper arm and a lower arm of each phase. Examples of the switching element include an IGBT, an FET, a thyristor, a GTO, and a transistor. The ON/OFF operation of the switching element in the power conversion unit 11 is controlled by the control unit 13 according to a PWM control method or a 120-degree power conduction method. By the control of the switching element by the control unit 13, the power conversion unit 11 selectively executes the rectification operation of converting AC power, which is input from the three-phase AC power supply 4 side, to DC power and outputting the DC power to the DC side, and the regeneration operation of converting DC power on the DC side to AC power and outputting the AC power to the three-phase AC power supply 4 side.

The rectification operation of the power conversion unit 11 in the converter 1 is implemented by the control unit 13 executing control to turn off all switching elements in the power conversion unit 11.

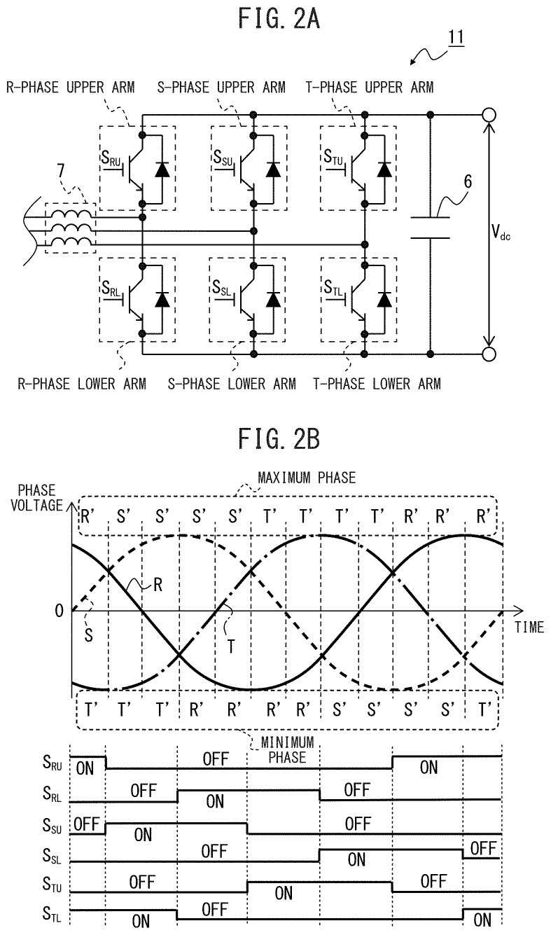

The regeneration operation of the power conversion unit 11 in the converter 1 is described in greater detail with reference to FIG. 2A and FIG. 2B. FIG. 2A is a diagram for describing the regeneration operation of the power conversion unit in the converter, and is a circuit diagram illustrating the power conversion unit composed of the three-phase bridge circuit. FIG. 2B is a diagram for describing the regeneration operation of the power conversion unit in the converter, and is a diagram illustrating a relationship between a waveform of a three-phase AC power supply voltage at the time of power supply regeneration and a switching pattern of switching elements in the power elements. In FIG. 2A and FIG. 2B, by way of example, a case is described in which the individual phases of the three-phase AC power supply 4 and the input terminals 32 of the corresponding phases in the input voltage detection unit 12 are correctly wired.

As illustrated in FIG. 2A, the power conversion unit 11 of the converter 1 includes three legs of an R phase, an S phase and a T phase. The leg of each phase includes an upper arm and a lower arm. The respective arms are referred to as an R-phase upper arm, an R-phase lower arm, an S-phase upper arm, an S-phase lower arm, a T-phase upper arm, and a T-phase lower arm. The R-phase upper arm is provided with a switching element S_{RU}, and the R-phase lower arm is provided with a switching element S_{RL}. The S-phase upper arm is provided with a switching element S_{SU}, and the S-phase lower arm is provided with a switching element S_{SL}. The T-phase upper arm is provided with a switching element S_{TU}, and the T-phase lower arm is provided with a switching element S_{TL}.

When the power conversion unit 11 of the converter 1 is caused to execute the regeneration operation, the control unit 13 controls the switching elements provided in the arms of the respective arms, in such a manner as to turn on the switching element provided in the upper arm of the phase in which the voltage detection value detected by the input voltage detection unit 12 becomes maximum, and to turn on the switching element provided in the lower arm of the phase in which the voltage detection value detected by the input voltage detection unit 12 becomes minimum. As described above, the R′ phase, S′ phase and T′ phase, which are the phase information for the control unit 13 to control the power conversion operation of the power conversion unit 11, are allocated to the voltage detection values for the three phases, which are detected by the input voltage detection unit 12.

For example, as illustrated in FIG. 2B, in a phase section in which the voltage detection value allocated as the R′ phase becomes maximum and the voltage detection value allocated as the T′ phase becomes minimum, the control unit 13 executes control to turn on the switching element S_{RU} of the R-phase upper arm and the switching element S_{TL}, of the T-phase lower arm of the power conversion unit 11, and to turn off the switching elements of the other arms. In a phase section in which the voltage detection value allocated as the S′ phase becomes maximum and the voltage detection value allocated as the T′ phase becomes minimum, the control unit 13 executes control to turn on the switching element S_{SU} of the S-phase upper arm and the switching element S_{TL}, of the T-phase lower arm of the power conversion unit 11, and to turn off the switching elements of the other arms. In a phase section in which the voltage detection value allocated as the S′ phase becomes maximum and the voltage detection value allocated as the R′ phase becomes minimum, the control unit 13 executes control to turn on the switching element S_{SU} of the S-phase upper arm and the switching element S_{RL}, of the R-phase lower arm of the power conversion unit 11, and to turn off the switching elements of the other arms. In a phase section in which the voltage detection value allocated as the T′ phase becomes maximum and the voltage detection value allocated as the R′ phase becomes minimum, the control unit 13 executes control to turn on the switching element S_{TU} of the T-phase upper arm and the switching element S_{RL}, of the R-phase lower arm of the power conversion unit 11, and to turn off the switching elements of the other arms. In a phase section in which the voltage detection value allocated as the T′ phase becomes maximum and the voltage detection value allocated as the S′ phase becomes minimum, the control unit 13 executes control to turn on the switching element S_{TU} of the T-phase upper arm and the switching element S_{SL} of the S-phase lower arm of the power conversion unit 11, and to turn off the switching elements of the other arms. In a phase section in which the voltage detection value allocated as the R′ phase becomes maximum and the voltage detection value allocated as the S′ phase becomes minimum, the control unit 13 executes control to turn on the switching element S_{RU} of the R-phase upper arm and the switching element S_{SL}, of the S-phase lower arm of the power conversion unit 11, and to turn off the switching elements of the other arms.

In this manner, at the time of the regeneration operation of the power conversion unit 11 in the converter 1, with respect to each switching element, the ON state is present in the phase section of 120 degrees in one cycle of the three-phase AC power supply 4, and, each time the voltage detection values that become maximum and minimum, which are detected by the input voltage detection unit 12, change, the switching elements that are turned on are changed.

Referring back to FIG. 1 for description, when the control unit 13 controls the regeneration operation of the power conversion unit 11 by executing the arithmetic process by using proper phase information and the phase voltage detection values detected by the input voltage detection unit 12, the regenerative current detection unit 14 detects the value of regenerative current flowing from the power conversion unit 11 to the three-phase AC power supply 4 side. Note that the input current detection unit 31 that is generally used in the converter 1 may be utilized as the regenerative current detection unit 14. In other words, the input current detection unit 31 that is generally provided detects the value of current (e.g., power-running current) flowing from the three-phase AC power supply 4 side to the power conversion unit 11 at the time of the rectification operation, and detects the value of regenerative current flowing from the power conversion unit 11 to the three-phase AC power supply 4 at the time of the regeneration operation. As one of the functions of the input current detection unit 31, the regenerative current detection unit 14 may be implemented.

The wiring state detection unit 15 detects the wiring state between the input voltage detection unit 12 and the three-phase AC power supply 4, based on the comparison between the value of regenerative current detected by the regenerative current detection unit 14 and a predetermined threshold. In other words, when the value of the regenerative current is equal to or lower than the threshold, the wiring state detection unit 15 determines that the wiring between the input voltage detection unit and the three-phase AC power supply is correct, and when the value of the regenerative current is greater than the threshold, the wiring state detection unit 15 determines that an error is present in the wiring between the input voltage detection unit and the three-phase AC power supply.

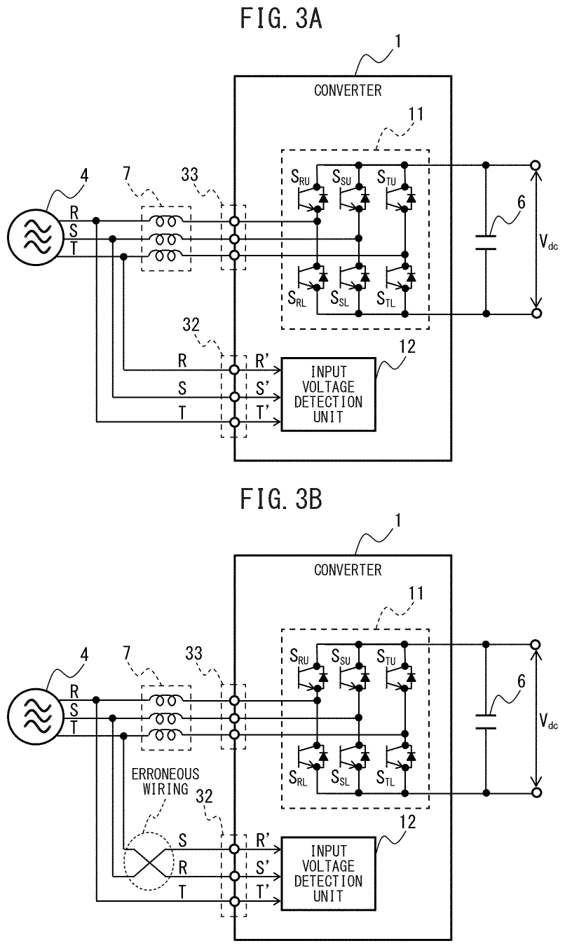

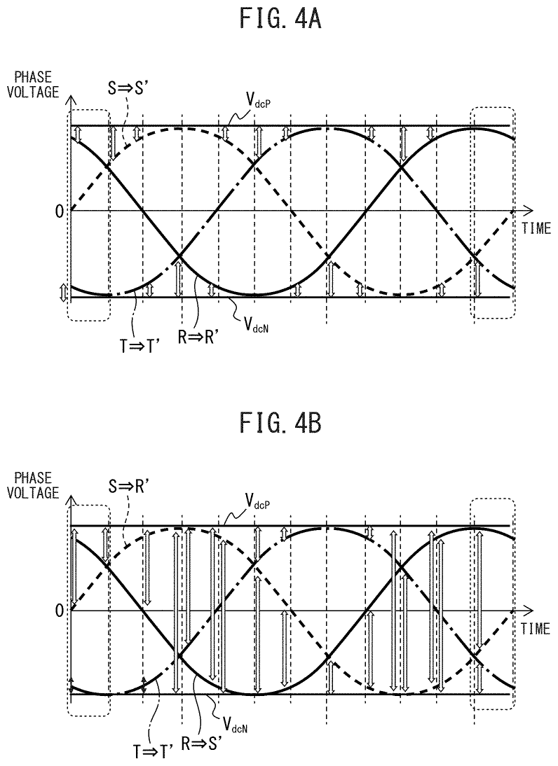

The regenerative current flowing from the power conversion unit 11 to the three-phase AC power supply 4 is greater when erroneous wiring is present between the input terminals 32 of the input voltage detection unit 12 and the three-phase AC power supply 4, than when the input terminals 32 of the input voltage detection unit 12 and the three-phase AC power supply 4 are correctly wired. The reason for this is described with reference to FIG. 3A, FIG. 3B, FIG. 4A and FIG. 4B.

FIG. 3A is a circuit diagram for describing a relationship between the wiring state between the three-phase AC power supply and the input voltage detection unit, and regenerative current, and illustrates a case where the respective phases of the three-phase AC power supply and the input terminals of the input voltage detection unit are correctly wired. FIG. 3B is a circuit diagram for describing the relationship between the wiring state between the three-phase AC power supply and the input voltage detection unit, and the regenerative current, and illustrates a case where erroneous wiring is present between the respective phases of the three-phase AC power supply and the input terminals of the input voltage detection unit. In FIG. 3A and FIG. 3B, an illustration of the structural elements of the converter 1, excluding the power conversion unit 11, input voltage detection unit 12 and input terminals 32, is omitted. In addition, in FIG. 3A and FIG. 3B, an illustration of the inverter 3 and motor 5 is omitted.

FIG. 4A is a waveform diagram illustrating a positive potential and a negative potential of a DC link voltage at the time of the regeneration operation of the converter, and voltage detection values detected by the input voltage detection unit, and illustrating a case where the respective phases of the three-phase AC power supply and the input terminals of the input voltage detection unit are correctly wired as illustrated in FIG. 3A. FIG. 4B is a waveform diagram illustrating a positive potential and a negative potential of a DC link voltage at the time of the regeneration operation of the converter, and voltage detection values detected by the input voltage detection unit, and illustrating a case where erroneous wiring is present between the respective phases of the three-phase AC power supply and the input terminals of the input voltage detection unit, as illustrated in FIG. 3B.

As illustrated in FIG. 3A, when the individual phases of the three-phase AC power supply 4 and the input terminals 32 of the corresponding phases in the input voltage detection unit 12 are correctly wired, the voltage of the R phase of the three-phase AC power supply 4 is detected as the voltage detection value of the R′ phase by the input voltage detection unit 12, the voltage of the S phase of the three-phase AC power supply 4 is detected as the voltage detection value of the S′ phase by the input voltage detection unit 12, the voltage of the T phase of the three-phase AC power supply 4 is detected as the voltage detection value of the T′ phase by the input voltage detection unit 12, and the voltage detection values are sent to the control unit 13. Thus, the order of the R′ phase, S′ phase and T′ phase, which are set for controlling the power conversion operation of the converter 1 by the control unit 13, agrees with the order of the R phase, S phase and T phase of the three-phase AC power supply 4. As illustrated in FIG. 4A, the control unit 13 recognizes the voltage detection values of the R phase, T phase and S phase of the three-phase AC power supply 4, which are input to the power conversion unit 11, as the voltage detection values of the R′ phase, T′ phase and S′ phase and ON/OFF controls the switching elements of the power conversion unit 11, thereby controlling the regeneration operation of the power conversion unit 11. Accordingly, as illustrated in FIG. 4A, since the switching element corresponding to the phase in which the voltage detection value becomes maximum is turned on, a potential difference (an outline arrow) between a positive potential V_{dcP} of the DC link voltage and the voltage detection value of the phase that becomes maximum, which is detected by the input voltage detection unit 12, is small. Similarly, since the switching element corresponding to the phase in which the voltage detection value becomes minimum is turned on, a potential difference (an outline arrow) between a negative potential V_{dcN} of the DC link voltage and the voltage detection value of the phase that becomes minimum, which is detected by the input voltage detection unit 12, is small. Accordingly, the regenerative current flowing from the power conversion unit 11 to the three-phase AC power supply 4 is small.

As illustrated in FIG. 3B, when there is such erroneous wiring that the R phase and the S phase of the three-phase AC power supply 4 are interchanged and connected to the input terminals 32 of the input voltage detection unit 12, the voltage of the “S phase” of the three-phase AC power supply 4 is detected as the voltage detection value of the R′ phase by the input voltage detection unit 12, the voltage of the “R phase” of the three-phase AC power supply 4 is detected as the voltage detection value of the S′ phase by the input voltage detection unit 12, the voltage of the T phase of the three-phase AC power supply 4 is detected as the voltage detection value of the T′ phase by the input voltage detection unit 12, and the voltage detection values are sent to the control unit 13. Thus, the order of the R′ phase, S′ phase and T′ phase, which are set for controlling the power conversion operation of the converter 1 by the control unit 13, does not agree with the order of the S phase, R phase and T phase of the three-phase AC power supply 4. As illustrated in FIG. 4B, although the control unit 13 recognizes the voltage detection value of the T phase as the voltage detection value of the T′ phase, the control unit 13 recognizes the voltage detection value of the S phase as the voltage detection value of the R′ phase, and recognizes the voltage detection value of the R phase as the voltage detection value of the S′ phase. In other words, the control unit 13 recognizes the normal R phase, T phase and S phase of the three-phase AC power supply 4, which are input to the power conversion unit 11, as the voltage detection values of the R′ phase, S′ phase and T′ phase, and ON controls the switching elements of the power conversion unit 11, thereby controlling the regeneration operation of the power conversion unit 11. Accordingly, as illustrated in FIG. 4B, since the switching element corresponding to the phase, in which the voltage detection value is not maximum, is turned on, a potential difference (an outline arrow) between the positive potential V_{dcP} of the DC link voltage and a voltage detection value corresponding to the switching element of the turned-on phase (i.e., a voltage detection value of the phase that is not maximum) becomes large. Similarly, a potential difference (an outline arrow) between the negative potential V_{dcN} of the DC link voltage and a voltage detection value corresponding to the switching element of the turned-on phase (i.e., a voltage detection value of the phase that is not minimum) is large. Thus, the regenerative current flowing from the power conversion unit 11 to the three-phase AC power supply 4 becomes large.

In this manner, when there is erroneous wiring between the input terminals 32 of the input voltage detection unit 12 and the three-phase AC power supply 4, the potential difference between the positive potential V_{dcP} of the DC link voltage and the voltage detection value of the phase that becomes maximum at the ON time (electrical conduction time) of the switching element, and the potential difference between the negative potential V_{dcN} of the DC link voltage and the voltage detection value of the phase that becomes minimum at the ON time (electrical conduction time) of the switching element, become larger than when the input terminals 32 of the input voltage detection unit 12 and the three-phase AC power supply 4 are correctly wired, and thus the regenerative current flowing from the power conversion unit 11 to the three-phase AC power supply 4 becomes larger.

When the control unit 13 controls the regeneration operation of the power conversion unit 11 by executing the arithmetic process by using the voltage detection values and the proper phase information, the wiring state detection unit 15 in the converter 1 according to the first embodiment of the present disclosure determines that the wiring between the input voltage detection unit 12 and the three-phase AC power supply 4 is correct, when the value of the regenerative current is equal to or lower than the threshold, and determines that an error is present in the wiring between the input voltage detection unit 12 and the three-phase AC power supply 4, when the value of the regenerative current is greater than the threshold. Thus, the wiring state detection unit 15 includes an allocation unit 21 and a determination unit 22.

The allocation unit 21 allocates proper phase information to the respective phases of voltage detection values that are used in the arithmetic process for the control of the regeneration operation of the power conversion unit 11 by the control unit 13. The “proper” phase information is phase information that is allocated to the voltage detection values detected by the input voltage detection unit 12, such that the power conversion unit 11 can normally execute the regeneration operation by the control of the control unit 13 in the state in which the input terminals 32 of the input voltage detection unit 12 and the three-phase AC power supply 4 are correctly wired. The allocated proper phase information is sent to the control unit 13.

When the control unit 13 controls the regeneration operation of the power conversion unit 11 by executing the arithmetic process by using the voltage detection values and the proper phase information, the determination unit 22 determines that the wiring between the input voltage detection unit 12 and the three-phase AC power supply 4 is correct, when the value of the regenerative current is equal to or lower than a threshold, and determines that an error is present in the wiring between the input voltage detection unit 12 and the three-phase AC power supply 4, when the value of the regenerative current is greater than the threshold. Note that since the regenerative current detection unit 14 provided in the input current detection unit 31 detects regenerative current for two phases or three phases, the determination unit 22 may compare the value of regenerative current of each phase with a threshold, and may determine that an error is present in the wiring between the input voltage detection unit 12 and the three-phase AC power supply 4, when the regenerative current for at least one phase is greater than the threshold. Alternatively, the determination unit 22 may convert the input current for two phases, which is detected by the regenerative current detection unit 14, to a vector norm on two-phase coordinates, and may determine that an error is present in the wiring between the input voltage detection unit 12 and the three-phase AC power supply 4, when the vector norm is greater than the threshold.

The threshold used in the wiring state detection process may be set as follows. For example, in the motor driving apparatus 100, in some cases, a threshold is set for detecting the occurrence of overcurrent on the AC input side of the power conversion unit 11 of the converter 1, and the threshold may be used commonly with the threshold used in the wiring state detection process. In addition, for example, before the factory shipment of the motor driving apparatus 100, the control unit 13 may execute the arithmetic process by using the voltage detection values and proper phase information, with the input terminals 32 of the input voltage detection unit 12 and the three-phase AC power supply 4 being correctly wired, and may cause the power conversion unit 11 to execute the regeneration operation, and a value higher by, for example, several-ten % than the value of the regenerative current detected by the regenerative current detection unit 14 at this time may be set to be the threshold. Note that the numerical value example illustrated here is merely an example, and may be another value. Besides, for example, by the simulation by a computer, the regeneration operation of the power conversion unit 11 may be reproduced in the state in which the input terminals 32 of the input voltage detection unit 12 and the three-phase AC power supply 4 are correctly wired, and the relationship between the current value (the value of regenerative current) on the AC input side of the power conversion unit 11 of the converter 1 and the presence/absence of the output of an arm signal in the motor driving apparatus 100 may be computed in advance, and then the threshold may be set. Note that the threshold may be stored in a rewritable storage unit (not illustrated) and may be rewritable by external equipment, and thereby the threshold, even after being once set, can be changed to a proper value where necessary.

The detection result (determination result) of the wiring state by the wiring state detection unit 15 is displayed, for example, on a display unit (not illustrated). Examples of the display unit include a single-unit display device, a display device attached to the converter 1, a display device attached to the motor driving apparatus 100, a display device attached to a personal computer, and a display device attached to a mobile terminal. Alternatively, the detection result (determination result) of the wiring state by the wiring state detection unit 15 may be output by, for example, acoustic equipment that produces sound, such as a speaker, a buzzer or a chime. According to the first embodiment of the present disclosure, an operator can easily understand the presence of erroneous wiring between the three-phase AC power supply 4 and the input voltage detection unit 12 in the converter 1. Thus, the operator may easily take a measure such as correctly reconnecting the power lines of the respective phases from the three-phase AC power supply to the input terminals of the corresponding phases in the input voltage detection unit.

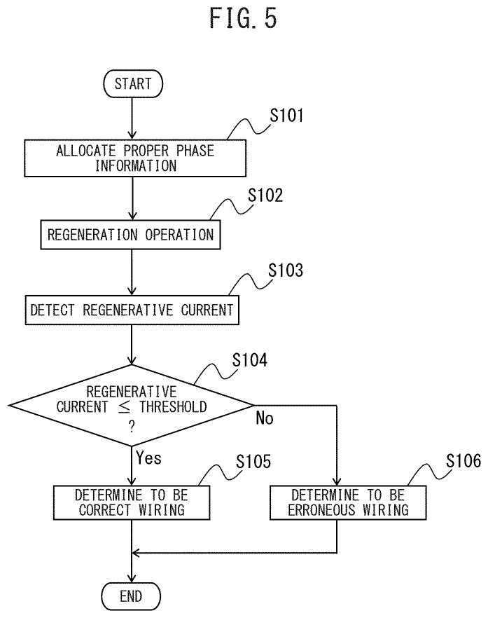

FIG. 5 is a flowchart illustrating an operation flow of a wiring state detection process in the converter and the motor driving apparatus according to the first embodiment of the present disclosure.

The wiring state detection process by the wiring state detection unit 15 is executed at a time of installation or maintenance of the motor driving apparatus 100 when the operator performs the wiring work between the input terminals 32 of the input voltage detection unit 12 and the power lines of the respective phases of the three-phase AC power supply 4. In step S101, the allocation unit 21 in the wiring state detection unit 15 allocates proper phase information to the respective phases of the voltage detection values used in the arithmetic process for the control of the regeneration operation of the power conversion unit 11 by the control unit 13. The allocated proper phase information is sent to the control unit 13.

In step S102, the control unit 13 controls the regeneration operation of the power conversion unit 11 by executing the arithmetic process by using the voltage detection values detected by the input voltage detection unit 12 and the proper phase information allocated by the allocation unit 21.

In step S103, the regenerative current detection unit 14 detects the value of regenerative current flowing from the power conversion unit 11 to the three-phase AC power supply 4 side.

In step S104, the value of the regenerative current detected by the regenerative current detection unit 14 and the threshold are compared, and it is determined whether the value of the regenerative current is equal to or less than the threshold. When it is determined that the value of the regenerative current is equal to or less than the threshold, the process advances to step S105, and when it is determined that the value of the regenerative current is greater than the threshold, the process advances to step S106.

In step S105, the determination unit 22 in the wiring state detection unit 15 determines that the wiring between the input voltage detection unit 12 and the three-phase AC power supply 4 is correct.

In step S106, the determination unit 22 in the wiring state detection unit 15 determines that an error is present in the wiring between the input voltage detection unit 12 and the three-phase AC power supply 4. Note that when it is determined that an error is present in the wiring between the input voltage detection unit 12 and the three-phase AC power supply 4, the control unit 13 may execute control to turn off all switching elements, thereby suppressing the occurrence of regenerative current. Thereby, a fault of the converter 1 and the motor driving apparatus 100 can more surely be prevented.

The detection result (determination result) of the wiring state by the determination unit 22 in the wiring state detection unit 15 in steps S105 and S106 is, for example, displayed on the display unit (not illustrated) or output by the acoustic equipment. Thereby, the operator can easily understand whether the wiring between the three-phase AC power supply 4 and the input voltage detection unit 12 in the converter 1 is erroneous or normal. Thus, when the operator confirms the presence of erroneous wiring between the input voltage detection unit 12 and the three-phase AC power supply 4, the operator can take such a measure as correctly rewiring them. When the operator confirms that the wiring between the input voltage detection unit 12 and the three-phase AC power supply 4 is normal, the operator can begin a preparation for causing the motor driving apparatus 100 to normally operate.

By extending the first embodiment, the proper phase information used in the arithmetic process by the control unit 13 may be automatically set by the phase information setting unit 16, based on the detection result of the wiring state by the above-described wiring state detection unit 15. Hereinafter, a setting process of proper phase information is described.

The allocation unit 21 illustrated in FIG. 1 allocates “tentative phase information”, which is temporary phase information, to the respective phases of the voltage detection values used in the arithmetic process for controlling the regeneration operation of the power conversion unit 11 by the control unit 13. While the wiring state detection process is being executed by the wiring state detection unit 15, the control unit 13 controls the power conversion operation of the power conversion unit 11 by executing the arithmetic process by using the voltage detection values of the respective phases detected by the input voltage detection unit 12, and the tentative phase information.

When the control unit 13 controls the regeneration operation of the power conversion unit 11 by executing the arithmetic process by using the voltage detection values and the tentative phase information, the determination unit 22 determines that the wiring between the input voltage detection unit 12 and the three-phase AC power supply 4 is correct, when the value of the regenerative current is equal to or lower than the threshold, and determines that an error is present in the wiring between the input voltage detection unit 12 and the three-phase AC power supply 4, when the value of the regenerative current is greater than the threshold.

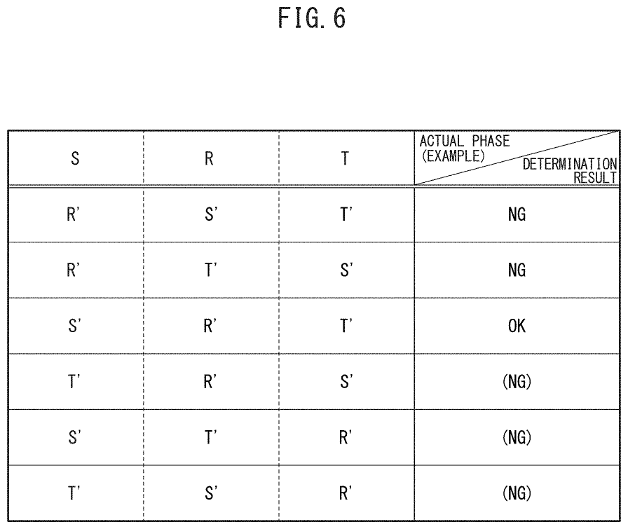

FIG. 6 is a view exemplarily illustrating a relationship between the phases of the three-phase AC power supply, and the phases defined by the tentative phase information. In accordance with the number of phases, “3”, of the three-phase AC power supply 4, three phases, i.e., a first phase, a second phase and a third phase, need to be set for controlling the power conversion operation of the converter 1 by the control unit 13. Thus, the tentative phase information allocated to the voltage detection values of the respective phases by the allocation unit 21 is six patterns in total. In other words, the tentative phase information includes first tentative phase information in which the first phase is the R′ phase, the second phase is the S′ phase and the third phase is the T′ phase; second tentative phase information in which the first phase is the R′ phase, the second phase is the T′ phase and the third phase is the S′ phase; third tentative phase information in which the first phase is the S′ phase, the second phase is the R′ phase and the third phase is the T′ phase; fourth tentative phase information in which the first phase is the T′ phase, the second phase is the R′ phase and the third phase is the S′ phase; fifth tentative phase information in which the first phase is the S′ phase, the second phase is the T′ phase and the third phase is the R′ phase; and sixth tentative phase information in which the first phase is the T′ phase, the second phase is the S′ phase and the third phase is the R′ phase.

A description is given of an example in which, as illustrated as “actual phases” in FIG. 6 by way of example, the power line of the S phase of the three-phase AC power supply 4 is connected to a terminal corresponding to a first phase among the input terminals 32 of the input voltage detection unit 12, the power line of the R phase of the three-phase AC power supply 4 is connected to a terminal corresponding to a second phase among the input terminals 32 of the input voltage detection unit 12, and the power line of the T phase of the three-phase AC power supply 4 is connected to a terminal corresponding to a third phase among the input terminals 32 of the input voltage detection unit 12. In the case of this example, since the orders of phases, which are defined by the first, second, and fourth to sixth tentative phase information, do not agree with the order of phases of the three-phase AC power supply 4 connected to the input terminals 32 of the input voltage detection unit 12, if the control of the regeneration operation of the power conversion unit 11 by the control unit 13 is executed by using the tentative phase information and the voltage detection values, the value of regenerative current detected by the regenerative current detection unit 14 increases and exceeds the threshold. Accordingly, the determination unit 22 detects that an error is present in the wiring between the input voltage detection unit 12 and the three-phase AC power supply 4. On the other hand, since the order of phases, which is defined by the third tentative phase information, agrees with the order of phases of the three-phase AC power supply 4 connected to the input terminals 32 of the input voltage detection unit 12, if the control of the regeneration operation of the power conversion unit 11 by the control unit 13 is executed by using the tentative phase information and the voltage detection values, the value of regenerative current detected by the regenerative current detection unit 14 decreases to the threshold or less. Accordingly, the determination unit 22 detects that the wiring between the input voltage detection unit 12 and the three-phase AC power supply 4 is correct.

The phase information setting unit 16 sets the tentative phase information, which is allocated by the allocation unit 21 when the determination unit 22 determines that the wiring between the input voltage detection unit 12 and the three-phase AC power supply 4 is correct, to be proper phase information that is used in the arithmetic process by the control unit 13. The set proper phase information is stored in the storage unit 23, and the phase information setting process is completed. Thereafter, the control unit 13 controls the power conversion operation of the power conversion unit 11 by executing the arithmetic process by using the voltage detection values of the respective phases detected by the input voltage detection unit 12, and the proper phase information stored in the storage unit 23. Note that since the proper phase information set by the phase information setting unit 16 is stored in the storage unit 23, the proper phase information stored in the storage unit 23 can be utilized also when the power supply to the converter 1 and the motor driving apparatus 100 is shut off and is then turned on once again.

On the other hand, when the determination unit 22 determines that an error is present in the wiring between the input voltage detection unit 12 and the three-phase AC power supply 4, the allocation unit 21 sets new tentative phase information in place of the tentative phase information allocated at the time of the determination. The control unit 13 controls the power conversion operation of the power conversion unit 11 by executing the arithmetic process by using the voltage detection values of the respective phases detected by the input voltage detection unit 12, and the tentative phase information, and the determination unit 22 executes the determination process in this state. The allocation unit 21 allocates the tentative phase information while changing the tentative phase information until the determination unit 22 determines that the wiring between the input voltage detection unit 12 and the three-phase AC power supply 4 is correct, and the control unit 13 executes the control of the regeneration operation of the power conversion unit 11 with the allocated tentative phase information. Since the tentative phase information is the six patterns in total, the allocation process of tentative phase information and the determination process of regenerative current are executed six times at maximum, until the determination unit 22 determines that the wiring between the input voltage detection unit 12 and the three-phase AC power supply 4 is correct.

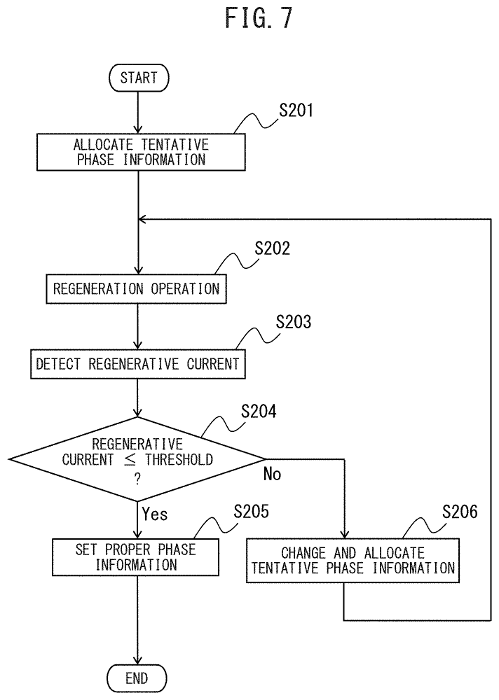

FIG. 7 is a flowchart illustrating an operation flow of the phase information setting process in the converter and the motor driving apparatus according to the first embodiment of the present disclosure.

The phase information setting process by the phase information setting unit 16 is executed at a time of installation or maintenance of the motor driving apparatus 100 when the operator performs the wiring work between the input terminals 32 of the input voltage detection unit 12 and the power lines of the respective phases of the three-phase AC power supply 4. In step S201, the allocation unit 21 in the wiring state detection unit 15 allocates tentative phase information to the respective phases of the voltage detection values used in the arithmetic process for the control of the regeneration operation of the power conversion unit 11 by the control unit 13. The allocated tentative phase information is sent to the control unit 13.

In step S202, the control unit 13 controls the regeneration operation of the power conversion unit 11 by executing the arithmetic process by using the voltage detection values detected by the input voltage detection unit 12 and the tentative phase information allocated by the allocation unit 21.

In step S203, the regenerative current detection unit 14 detects the value of regenerative current flowing from the power conversion unit 11 to the three-phase AC power supply 4 side.

In step S204, the value of the regenerative current detected by the regenerative current detection unit 14 and the threshold are compared, and it is determined whether the value of the regenerative current is equal to or less than the threshold. When it is determined that the value of the regenerative current is equal to or less than the threshold, the process advances to step S205, and when it is determined that the value of the regenerative current is greater than the threshold, the process advances to step S206.

When it is determined in step S204 that the value of the regenerative current is greater than the threshold, the allocation unit 21 sets, in step S206, new tentative phase information in place of the tentative phase information allocated at the time of the determination. Thereafter, the process returns to step S202. The process of steps S202 to S204 and step S206 is repeatedly executed until it is determined in step S204 that the value of the regenerative current is equal to or less than the threshold (i.e., until it is determined that the wiring between the input voltage detection unit 12 and the three-phase AC power supply 4 is correct) (six times at maximum).

When it is determined in step S204 that the value of the regenerative current is equal to or less than the threshold, the determination unit 22 determines in step S205 that the wiring between the input voltage detection unit 12 and the three-phase AC power supply 4 is correct, and sets the tentative phase information allocated by the allocation unit 21 at this time to be proper information that is used in the arithmetic process by the control unit 13. The set proper phase information is stored in the storage unit 23, and the wiring state detection process by the wiring state detection unit 15 is completed. After the completion of the wiring state detection process by the wiring state detection unit 15, the control unit 13 controls the power conversion operation of the power conversion unit 11 by executing the arithmetic process by using the voltage detection values of the respective phases detected by the input voltage detection unit 12 and the proper phase information stored in the storage unit 23.

In this manner, according to the first embodiment, even when erroneous wiring is present between the three-phase AC power supply 4 and the input voltage detection unit 12, the phase information, which can cause the power conversion unit 11 to normally execute the regeneration operation, can automatically be allocated to the voltage detection values detected by the input voltage detection unit 12, by the wiring state detection process of the wiring state detection unit and the phase information setting process of the phase information setting unit 16. Accordingly, it is possible to prevent an alarm stop or a fault of the converter 1 and the motor driving apparatus 100 due to erroneous wiring. In addition, since the appropriate phase information is automatically allocated to the voltage detection values, the motor driving apparatus 100 is operated without the need to rewire the input voltage detection unit 12 and the three-phase AC power supply 4, and thus the work efficiency is improved. For example, even if an operator is not familiar with the wiring work and performs erroneous wiring, the phase information that can cause the power conversion unit 11 to normally execute the regeneration operation is automatically set, and therefore an alarm stop or a fault of the converter 1 and the motor driving apparatus 100 can be prevented.

Next, a converter and a motor driving apparatus according to a second embodiment of the present disclosure are described. Like the first embodiment, the second embodiment utilizes the characteristic that “the regenerative current flowing from the power conversion unit 11 to the three-phase AC power supply 4 is greater when erroneous wiring is present between the input terminals 32 of the input voltage detection unit 12 and the three-phase AC power supply 4, than when the input terminals 32 of the input voltage detection unit 12 and the three-phase AC power supply 4 are correctly wired.” The second embodiment, however, is different from the first embodiment in that when the control unit controls the regeneration operation of the power conversion unit by executing the arithmetic process by using the voltage detection values and the tentative phase information, the tentative phase information, which is allocated by the allocation unit at a time when a minimum value of the regenerative current is detected by the regenerative current detection unit, is set to be proper phase information used in the arithmetic process by the control unit.

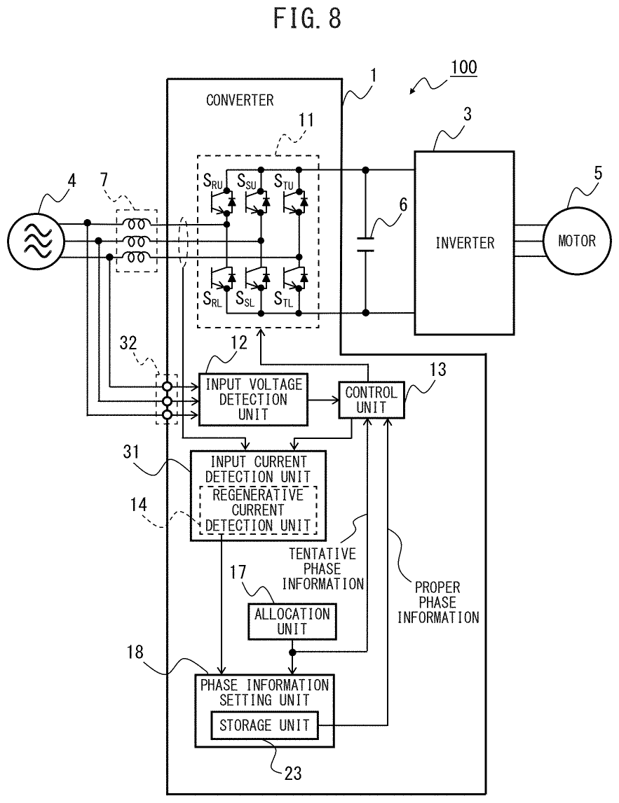

FIG. 8 is a diagram illustrating the converter and the motor driving apparatus according to the second embodiment of the present disclosure.

By way of example, a case is illustrated in which a motor 5 is controlled by a motor driving apparatus 100 that is connected to a three-phase AC power supply 4. Examples of the three-phase AC power supply 4 include a three-phase AC 400 V power supply, a three-phase AC 200 V power supply and a three-phase AC 600 V power supply. In the present embodiment, the kind of motor 5 is not particularly limited, and the motor 5 may be, for example, an induction motor or a synchronous motor. The number of phases of the motor 5 does not particularly limit the present embodiment, and may be, for example, three phases or a single phase. In the illustrated example, it is assumed that the motor 5 is a three-phase AC motor. Examples of the machine, in which the motor 5 is provided, include a machine tool, a robot, a forging machine, an injection molding machine, and an industrial machine.

As illustrated in FIG. 8, the motor driving apparatus 100 according to the second embodiment of the present disclosure includes a converter 1, an inverter 3, a DC link capacitor 6, and an AC reactor 7. The converter 1 according to the second embodiment of the present disclosure includes a power conversion unit 11, an input voltage detection unit 12, a control unit 13, a regenerative current detection unit 14, an allocation unit 17, and a phase information setting unit 18.

The inverter 3, DC link capacitor 6, AC reactor 7, power conversion unit 11, input voltage detection unit 12, control unit 13 and regenerative current detection unit 14 are the same as in the first embodiment.

The allocation unit 17 allocates tentative phase information to the respective phases of voltage detection values that are used in the arithmetic process for the control of the regeneration operation of the power conversion unit 11 by the control unit 13. The tentative phase information is as described in connection with the first embodiment. While the phase information setting process is being executed by the phase information setting unit 18, the control unit 13 controls the power conversion operation of the power conversion unit 11 by executing the arithmetic process by using the voltage detection values of the respective phases detected by the input voltage detection unit 12, and the tentative phase information. As described above, the tentative phase information allocated to the voltage detection values of the respective phases by the allocation unit 17 is six patterns in total, and the control of the regeneration operation of the power conversion unit 11 by the control unit 13 is executed with respect to the tentative phase information of all the six patterns, and the value of the regenerative current is detected by the regenerative current detection unit 14. In other words, the regenerative current detection unit 14 detects the values of six kinds of regenerative current in accordance with the tentative phase information of the six patterns. The detected values of the regenerative current are correlated with the corresponding tentative phase information, and stored in the storage unit 23.

When the control unit 13 controls the regeneration operation of the power conversion unit 11 by executing the arithmetic process by using the voltage detection values and the tentative phase information, the phase information setting unit 18 reads, from the storage unit 23, the tentative phase information that is allocated by the allocation unit 17 at a time when a minimum value of the regenerative current is detected by the regenerative current detection unit 14, and sets the tentative phase information to be proper phase information used in the arithmetic process by the control unit 13. The set proper phase information is stored in the storage unit 23, and the phase information setting process is completed. Thereafter, the control unit 13 controls the power conversion operation of the power conversion unit 11 by executing the arithmetic process by using the voltage detection values of the respective phases detected by the input voltage detection unit 12, and the proper phase information stored in the storage unit 23. Note that since the proper phase information set by the phase information setting unit 18 is stored in the storage unit 23, the proper phase information stored in the storage unit 23 can be utilized also when the power supply to the converter 1 and the motor driving apparatus 100 is shut off and is then turned on once again.

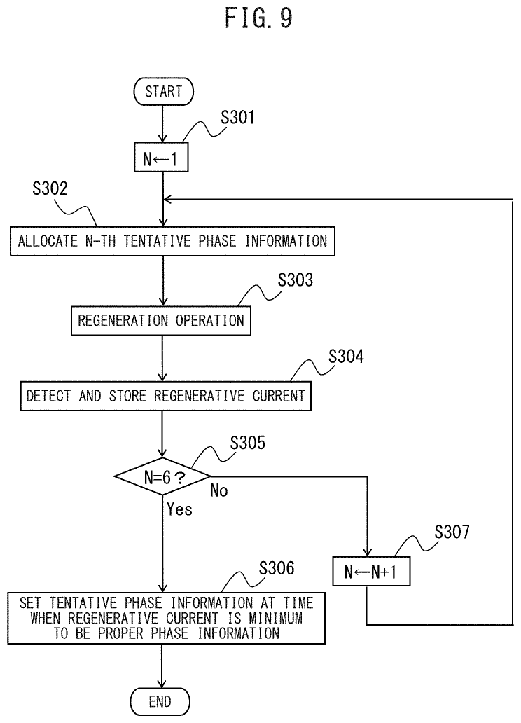

FIG. 9 is a flowchart illustrating an operation flow of the phase information setting process in the converter and the motor driving apparatus according to the first embodiment of the present disclosure.

The phase information setting process by the phase information setting unit 18 is executed at a time of installation or maintenance of the motor driving apparatus 100 when the operator performs the wiring work between the input terminals 32 of the input voltage detection unit 12 and the power lines of the respective phases of the three-phase AC power supply 4. As described with reference to FIG. 6, the tentative phase information allocated to the voltage detection values of the respective phases by the allocation unit 17 is six patterns in total, and the tentative phase information of the six patterns is identified by an identification number N (where 1≤N≤6).

In step S301, the allocation unit 17 sets, as an initial setting, the identification number N of tentative phase information to be 1. The setting of 1 of the identification number N of tentative phase information in step S301 may be executed, for example, by an operator's input operation using an input device to the converter 1, or may be automatically executed at a time of the start of the phase information setting process by the phase information setting unit 18, or may be automatically executed at a time of powering on the motor driving apparatus 100 or the converter 1.

In step S302, the allocation unit 17 allocates N-th tentative phase information to the respective phases of the voltage detection values used in the arithmetic process for the control of the regeneration operation of the power conversion unit 11 by the control unit 13. The allocated N-th tentative phase information is sent to the control unit 13.

In step S303, the control unit 13 controls the regeneration operation of the power conversion unit 11 by executing the arithmetic process by using the voltage detection values detected by the input voltage detection unit 12 and the N-th tentative phase information allocated by the allocation unit 21.

In step S304, the regenerative current detection unit 14 detects the value of regenerative current flowing from the power conversion unit 11 to the three-phase AC power supply 4 side, and stores the value in the storage unit 23.

In step S305, the allocation unit 17 determines whether the identification number N of tentative phase information is 6. When it is determined that the identification number N of tentative phase information is 6, the process advances to step S306, and when it is not determined that the identification number N of tentative phase information is 6, the process advances to step S307.

In step S307, the allocation unit 17 increments the identification number N of tentative phase information by one. Thereafter, the process returns to step S302.

The phase information setting unit 18 reads the tentative phase information, which is allocated by the allocation unit 17 at a time when a minimum value of the regenerative current is detected among the values of the six kinds of regenerative current corresponding to the tentative phase information of the six patterns stored in the storage unit 23, and sets the tentative phase information to be proper phase information used in the arithmetic process by the control unit 13. The set proper phase information is stored in the storage unit 23, and the phase information setting process is completed. Thereafter, the control unit 13 controls the power conversion operation of the power conversion unit 11 by executing the arithmetic process by using the voltage detection values of the respective phases detected by the input voltage detection unit 12, and the proper phase information stored in the storage unit 23.

In this manner, according to the second embodiment, by the phase information setting process of the phase information setting unit 18, even when erroneous wiring is present between the three-phase AC power supply 4 and the input voltage detection unit 12, the phase information, which can cause the power conversion unit 11 to normally execute the regeneration operation, can automatically be allocated to the voltage detection values detected by the input voltage detection unit 12. Accordingly, it is possible to prevent an alarm stop or a fault of the converter 1 and the motor driving apparatus 100 due to erroneous wiring. Furthermore, since the appropriate phase information is automatically allocated to the voltage detection values, the motor driving apparatus 100 is operated without the need to rewire the input voltage detection unit 12 and the three-phase AC power supply 4, and thus the work efficiency is improved. For example, even if an operator is not familiar with the wiring work and performs erroneous wiring, an alarm stop or a fault of the converter 1 and the motor driving apparatus 100 can be prevented.

The control unit 13, wiring state detection unit 15, phase information setting units 16 and 18, and allocation unit 17 may be composed of only an arithmetic processing apparatus, or may be composed of a combination of an analog circuit and an arithmetic processing apparatus, or may be composed of only an analog circuit. Arithmetic processing apparatuses, which can constitute the control unit 13, wiring state detection unit 15, phase information setting units 16 and 18, and allocation unit 17, include, for example, an IC, an LSI, a CPU, an MPU, and a DSP. For example, when the control unit 13, wiring state detection unit 15, phase information setting units 16 and 18, and allocation unit 17 are constituted in a software program form, the arithmetic processing apparatus is operated according to the software program, and thereby the functions of the control unit 13, wiring state detection unit 15, phase information setting units 16 and 18, and allocation unit 17 can be implemented. Alternatively, the control unit 13, wiring state detection unit 15, phase information setting units 16 and 18, and allocation unit 17 may be implemented as a semiconductor integrated circuit in which a software program that implements the functions of the respective units is written. Alternatively, the control unit 13, wiring state detection unit 15, phase information setting units 16 and 18, and allocation unit 17 may be implemented as a storage medium in which a software program that implements the functions of the respective units is written. Alternatively, the control unit 13, wiring state detection unit 15, phase information setting units 16 and 18, and allocation unit 17 may be provided, for example, in a numerical control apparatus of a machine tool, or may be provided in a robot controller that controls a robot.

The storage unit 23 is composed of, for example, an electrically erasable/writable nonvolatile memory such as an EEPROM (registered trademark), or a random access memory capable of reading and writing at high speed, such as a DRAM or an SRAM.

The input voltage detection unit 12 and the regenerative current detection unit 14 may be composed of a combination of an analog circuit and an arithmetic processing apparatus, or may be composed of only an arithmetic processing apparatus, or may be composed of only an analog circuit. As regards the input voltage detection unit 12 and the regenerative current detection unit 14, an input voltage detection unit and a regenerative current detection unit, which are generally provided in the converter 1 or motor driving apparatus 100, may be utilized.

### REFERENCE SIGNS LIST

1 Converter
3 Inverter
4 Three-phase AC power supply
5 Motor
6 DC link capacitor
7 AC reactor
11 Power conversion unit
12 Input voltage detection unit
13 Control unit
14 Regenerative current detection unit
15 Wiring state detection unit
16 Phase information setting unit
21 Allocation unit
22 Determination unit
23 Storage unit
31 Input current detection unit
32 Input terminal
100 Motor driving apparatus
S_{RU} Switching element of R-phase upper arm
S_{RL}, Switching element of R-phase lower arm
S_{SU} Switching element of S-phase upper arm
S_{SL} Switching element of S-phase lower arm
S_{TU} Switching element of T-phase upper arm
S_{TL} Switching element of T-phase lower arm

1. A converter with a power supply regeneration function, comprising:
a power conversion unit configured to selectively execute a rectification operation of converting AC power, which is input from a three-phase AC power supply side, to DC power and outputting the DC power to a DC side, and a regeneration operation of converting DC power on the DC side to AC power and outputting the AC power to the three-phase AC power supply side;
an input voltage detection unit configured to detect voltage detection values in regard to individual phase voltages that are input from the three-phase AC power supply side to the power conversion unit;
a control unit configured to control the rectification operation and the regeneration operation of the power conversion unit, based on an arithmetic process using the voltage detection values;
a regenerative current detection unit configured to detect a value of regenerative current flowing from the power conversion unit to the three-phase AC power supply side at a time of the regeneration operation of the power conversion unit; and
a wiring state detection unit configured to detect a wiring state between the input voltage detection unit and the three-phase AC power supply, based on a comparison between a value of the regenerative current and a predetermined threshold.

2. The converter according to claim 1, wherein the wiring state detection unit includes:
an allocation unit configured to allocate proper phase information to respective phases of the voltage detection values that are used in the arithmetic process by the control unit; and
a determination unit configured to determine, when the control unit controls the regeneration operation of the power conversion unit by executing the arithmetic process by using the voltage detection values and the proper phase information, that wiring between the input voltage detection unit and the three-phase AC power supply is correct in a case where the value of the regenerative current is equal to or lower than the threshold, and to determine that an error is present in the wiring between the input voltage detection unit and the three-phase AC power supply in a case where the value of the regenerative current is greater than the threshold.

3. The converter according to claim 1, wherein the wiring state detection unit includes:
an allocation unit configured to allocate tentative phase information to respective phases of the voltage detection values that are used in the arithmetic process by the control unit; and
a determination unit configured to determine, when the control unit controls the regeneration operation of the power conversion unit by executing the arithmetic process by using the voltage detection values and the tentative phase information, that wiring between the input voltage detection unit and the three-phase AC power supply is correct in a case where the value of the regenerative current is equal to or lower than the threshold, and to determine that an error is present in the wiring between the input voltage detection unit and the three-phase AC power supply in case that the value of the regenerative current is greater than the threshold.

4. The converter according to claim 3, further comprising a phase information setting unit configured to set the tentative phase information, which is allocated by the allocation unit when the determination unit determines that the wiring between the input voltage detection unit and the three-phase AC power supply is correct, to be proper phase information used in the arithmetic process by the control unit.

5-8. (canceled)

9. The converter according to claim 4, wherein the phase information setting unit includes a storage unit configured to store the proper phase information that is set.

10. The converter according to claim 1, wherein
the power conversion unit includes a three-phase bridge circuit in which a power element composed of a diode and a switching element connected to the diode in an inverse parallel manner is provided in each of upper arms and lower arms of the respective phases, and
the control unit causes the power conversion unit to execute the regeneration operation by controlling the power conversion unit such that the switching element provided in the upper arm of the phase in which the voltage detection value becomes maximum is turned on and the switching element provided in the lower arm of the phase in which the voltage detection value becomes minimum is turned on.

11. A converter with a power supply regeneration function, comprising:
a power conversion unit configured to selectively execute a rectification operation of converting AC power, which is input from a three-phase AC power supply side, to DC power and outputting the DC power to a DC side, and a regeneration operation of converting DC power on the DC side to AC power and outputting the AC power to the three-phase AC power supply side;
an input voltage detection unit configured to detect voltage detection values in regard to individual phase voltages that are input from the three-phase AC power supply side to the power conversion unit;
a control unit configured to control the rectification operation and the regeneration operation of the power conversion unit, based on an arithmetic process using the voltage detection values;
a regenerative current detection unit configured to detect a value of regenerative current flowing from the power conversion unit to the three-phase AC power supply side at a time of the regeneration operation of the power conversion unit;
an allocation unit configured to allocate tentative phase information to respective phases of the voltage detection values that are used in the arithmetic process by the control unit; and
a phase information setting unit configured to set, when the control unit controls the regeneration operation of the power conversion unit by executing the arithmetic process by using the voltage detection values and the tentative phase information, the tentative phase information, which is allocated by the allocation unit when the regenerative current detection unit detects a minimum value of the regenerative current, to be proper phase information used in the arithmetic process by the control unit.

12. The converter according to claim 11, wherein the phase information setting unit includes a storage unit configured to store the proper phase information that is set.

13. The converter according to claim 11, wherein
the power conversion unit includes a three-phase bridge circuit in which a power element composed of a diode and a switching element connected to the diode in an inverse parallel manner is provided in each of upper arms and lower arms of the respective phases, and
the control unit causes the power conversion unit to execute the regeneration operation by controlling the power conversion unit such that the switching element provided in the upper arm of the phase in which the voltage detection value becomes maximum is turned on and the switching element provided in the lower arm of the phase in which the voltage detection value becomes minimum is turned on.

14. A motor driving apparatus comprising:
the converter according to claim 1; and
an inverter connected to the DC side of the converter and configured to convert DC power on the DC side to AC power for motor driving.
